(19) United States
(12) Patent Application Publication
(10) Pub. No.: US 2017/0260638 A1
(43) Pub. Date: Sep. 14, 2017

(54) METHOD FOR MANUFACTURING COMPOSITE PART OF POLYMER AND METAL

(71) Applicant: J. T. LABS LIMITED, On Lok Tsuen (CN)

(72) Inventors: Tit Shing WONG, Kowloon Toong (CN); Sui Kay WONG, North Point (CN); Wai Choi LEUNG, Sai Kung (CN); Si Ping YANG, Guang Zhou (CN); Siu Wai TANG, Tin Shu Wai (CN)

(21) Appl. No.: 15/069,008

(22) Filed: Mar. 14, 2016

(51) Int. Cl. C25D 1/20; B29C 35/02; C25D 5/48; B29C 41/22

(52) U.S. Cl. CPC C25D 1/20; B29C 41/22; B29C 35/02; C25D 5/48; B29K 2105/16

(57) ABSTRACT

A method for manufacturing a composite part of polymer and metal utilizes a mold having a plurality of mold parts and forming a layer of metal on at least one inner or cavity-facing surface of the mold. Thereafter the mold parts are assembled to one another to form a mold cavity defined in part by the layer of metal. The mold cavity is then filled with resin material so that the resin material is in contact with the layer of metal. A curing or hardening of the resin material in the mold cavity is followed by an opening of the mold and the removal of a composite part having a metal shell or outer layer and a polymeric backing or inner layer.

### BACKGROUND OF THE INVENTION

This invention relates to a method for manufacturing a composite part of polymer and metal. The metal-resin composite process is particularly suitable for making model vehicles such as automobiles, planes, trucks, and ships or boats.

Currently, most of collectible model vehicles are produced by one of two processes, namely, hot chamber die casting in zinc alloy and cold casting in resin. These processes each have their advantages and disadvantages.

With hot chamber die casting, the advantages are that the parts produced have a cold metal hand feel and a robust structure while the disadvantages are that dies are expensive and take time to build. In addition, the die casted parts take time to trim, polish and clean up blur. No fine detail can be done.

With cold casting of resin, the advantages are that the molds are inexpensive and take less time to build. Also, cold cast parts can have fine detail and require less time to trim and clean up. The disadvantages of cold-cast resin parts is that they do not have a metallic feel. Moreover structure robustness is poorer.

### OBJECTS OF THE INVENTION

It is an object of the present invention to provide an improved method for making parts such as toy or model parts.

It is a more specific object of the present invention to provide such a method where the finished part has a cold metal feel and a structural robustness.

A further object of the present invention is to provide such a method that is less expensive and faster than hot chamber die casting.

These and other objects of the present invention will be apparent from the descriptions, and drawings herein. Although every object of the invention is attainable by at least one embodiment of the invention, there is not necessarily any single embodiment that achieves all of the objects of the invention.

### SUMMARY OF THE INVENTION

A method for manufacturing a composite part of polymer and metal comprises, in accordance with the present invention, providing a mold having a plurality of mold parts and forming a layer of metal on at least one inner or cavity-facing surface of the mold. Thereafter the mold parts are assembled to one another to form a mold cavity defined in part by the layer of metal. The method further comprises filling the mold cavity with resin material so that the resin material is in contact with the layer of metal, curing or hardening the resin material in the mold cavity, and thereafter opening the mold and removing a part having a metal shell or outer layer and a polymeric backing or inner layer.

Pursuant to another feature of the present invention, the method additionally comprises mixing the resin material with a filler material prior to the filling of the mold cavity, where the filler material is a mineral or metal powder and/or fiber. The mineral or metal powder may be calcium carbonate, silicon oxide, gypsum, copper, iron, zinc, bronze or mixtures thereof, while the fiber may be glass, graphite, polyester, nylon, cotton fibers or mixtures thereof.

The layer of metal is typically formed on the inner or cavity-facing surface of the mold by an electroforming process such as electroplating. In that case a mold part serves as an electrode in the process.

The electroforming process may include inserting at least a portion of the mold into an electroforming bath, removing the mold portion from the bath together with the layer of metal, and washing and drying the mold portion together with the layer of metal, upon an attainment of a predetermined thickness of the layer of metal and prior to the filling of the mold with the resin material.

The resin material may be a cold cast material. The resin material may be taken from the group consisting of epoxy, polyester, and polyurethane.

Pursuant to one embodiment of the present invention, the forming of the layer of metal includes forming a plurality of layers of metal each on an inner or cavity-facing surface of a respective one of the mold parts. In that case, the filling of the mold cavity with resin material includes flowing the resin material into contact with each of the layers of metal. The curing or hardening of the resin material is carried out so that the cured or hardened resin material is bonded to each of the layers of metal. The part removed from the mold has metal shells or outer layers and a single polymeric backing or core.

The mold may be made of a material taken from the group consisting of rubber, silicon rubber, epoxy, polyester, and polyurethane.

Where the mold includes a cavity-type first mold part and a core-type second mold part, the layer of metal is formed on an inner surface of the first mold part.

The metal may be taken from the group consisting of copper, nickel, silver and gold.

The layer or layers of metal are formed so that each metal shell or outer layer has a thickness between about 0.3 mm and 1.5 mm.

The method may further comprise covering the one or more inner or cavity-facing surfaces of the mold with mold release agent prior to the injecting of resin material into the mold cavity.

The filling of the mold more particularly includes injecting the resin material into the mold cavity to fill up a space in between a back of the layer of metal, in the case of a one-sided metal-faced part and a core half of the mold.

The method preferably entails bonding the resin material to the layer of metal during the curing or hardening of the resin material, to thereby form a single part after curing.

The composite part made by the present process is typically a part of a toy or model article. In that case, the method further comprising applying decorative elements to the metal shell or outer layer in conformity with the toy or model article.

The present method to make parts which are composites of a metal outer shell and resin filled body provides parts with cold metal hand feel. The parts are robust, like die casted parts. Molds are inexpensive and take less time to build. The part can have fine details. Also, the parts take less time to trim and clean up.

### BRIEF DESCRIPTION OF THE DRAWINGS

FIG. 1 is a cross sectional view of a mold including cavity and core halves for manufacturing a resin part or polymeric piece with a metal shell or layer on one side.

FIG. 2 is a cross sectional view of a cavity mold half with a metal shell or layer along an inner surface of the mold half, after an electroforming process.

FIG. 3 is a cross sectional view of clamped cavity and core halves after resin is injected.

FIG. 4 is a cross sectional view of a completed resin composite part with a metal shell on one side or surface, removed from the mold.

FIG. 5 is a cross sectional view of a two-part mold for manufacturing a resin part or polymeric piece with a metal shell or layer on each or two opposing sides.

FIG. 6 is a cross sectional view of two mold parts with metal shells or layers disposed along inner surfaces of the two mold parts, after an electroforming process.

FIG. 7 is a cross sectional view of clamped mold parts after resin is injected into a mold cavity formed by the two mold parts with metal shells or layers thereon.

FIG. 8 is a cross sectional view of a completed resin composite part with metal shells or layers on opposing sides or surfaces, removed from the mold.

### DETAILED DESCRIPTION

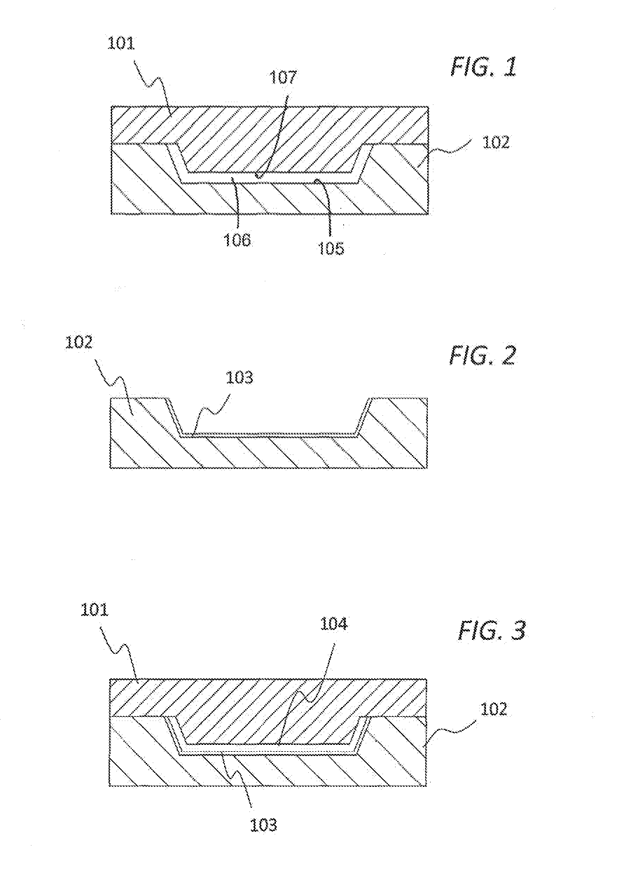

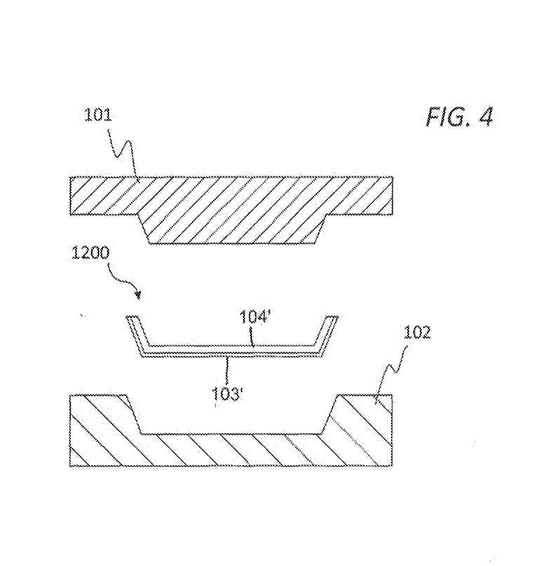

A method for manufacturing a composite part 1200 (FIG. 4) of polymer and metal, such as a model airplane fuselage half, particularly where the metal is provided only on one side of the polymer piece and the latter is a backing for the metal, utilizes a mold 100 (FIG. 1) having a plurality of mold parts 101 and 102 and more specifically a core mold half 101 and a cavity mold half 102. As depicted in FIG. 2, a layer of metal 103 is formed, preferably by an electroforming or electro-deposition process, on an inward- or cavity-facing surface 105 of the cavity mold half 102. Thereafter the mold parts 101 and 102 are assembled and clamped to one another, as shown in FIG. 3, to form a mold cavity 106 (FIG. 1) defined on one side by the layer of metal 103 and on an opposing side by an inward- or cavity-facing surface 107 of core mold half 101. The method then entails filling the mold cavity 106 with resin material 104 so that the resin material is in contact with the layer of metal 103. The resin material 104 in the mold cavity 106 is then cured or hardened, with a bonding of the resin material 104 to the metal layer 103. After the curing or hardening of the resin material 104, the mold 100 is opened and a composite part 1200 is removed, that part having a metal shell or outer layer 103′ and a polymeric backing or inner layer 104′.

The resin material 104 may be mixed with a filler material prior to the filling of the mold cavity 106, where the filler material is a mineral or metal powder and/or fiber. The mineral or metal powder may be calcium carbonate, silicon oxide, gypsum, copper, iron, zinc, bronze or mixtures thereof, while the fiber may be glass, graphite, polyester, nylon, cotton fibers or mixtures thereof. Other suitable additives may be used alone or in combination with one or more of the afore-mentioned.

Where metal layer 103 is formed by an electroforming process such as electroplating, cavity mold half 102 serves as an electrode. Mold half 102 may be made in part of an electrically conductive material such as a metal (metal alloys are contemplated by the term “metal” as used herein). Where mold half 102 is made of a polymeric or other naturally non-conductive material, the electrode function may be implemented as a metal insert embedded in the mold half 102.

The electroforming process may include inserting at least a portion of the mold half 102 into an electroforming bath, removing the mold half 102 from the bath together with the layer of metal 103 formed thereof, and washing and drying the mold half 102 together with the layer of metal 103, upon an attainment of a predetermined thickness of the layer of metal 103 and prior to the filling of the mold cavity 106 with the resin material 104.

The resin material 104 may be a cold cast material. The resin material 104 is exemplarily taken from the group consisting of epoxy, polyester, and polyurethane.

The filling of the mold cavity 100 with resin material 104 more particularly includes injecting the resin material 104 into the mold cavity 106 to fill up a space in between a back of the layer of metal 103, in the case of a one-sided metal-faced part 1200, and a core half 101 of the mold 100. The method may further comprise covering the one or more inner or cavity-facing surfaces 107 of the respective mold 100 with mold release agent prior to the filling of the mold cavity 106 with the resin material 104.

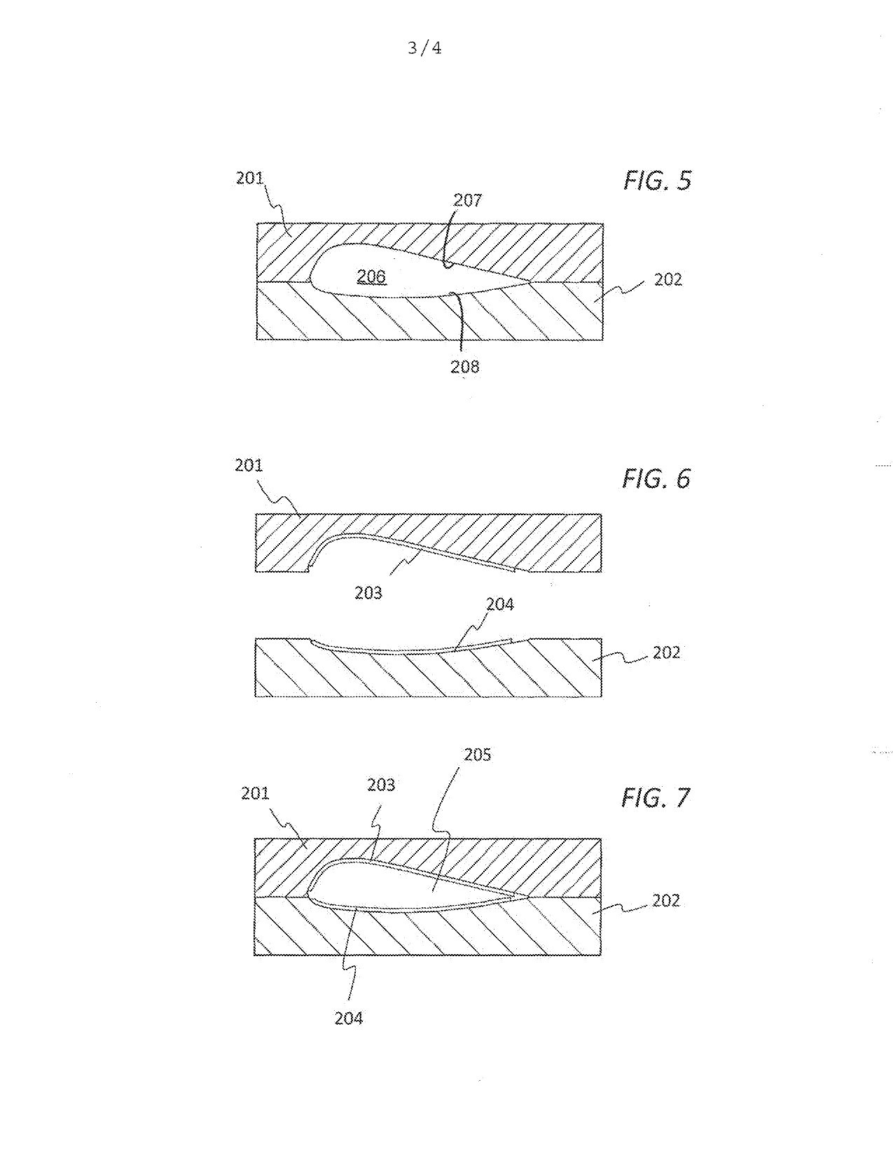

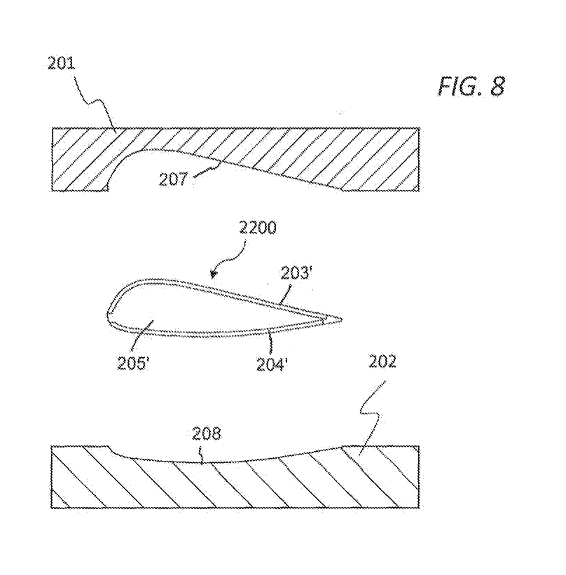

A method for manufacturing a composite part 2200 (FIG. 8) such as a wing of a model plane, where the composite part includes polymer and metal portions, particularly where the metal is provided on two opposing sides of the polymer piece and the latter is a backing for the metal, utilizes a mold 200 (FIG. 5) having a plurality of mold parts 201 and 202 that cooperate to define a cavity 206. As depicted in FIG. 6, layers of metal 203 and 204 are formed, preferably by an electroforming or electro-deposition process, on inward- or cavity-facing surfaces 207 and 208 of the cavity mold halves 201 and 202. Thereafter the mold parts 201 and 202 are assembled and clamped to one another, as shown in FIG. 7, to form mold cavity 206 (FIG. 5) defined on one side by the layer of metal 203 and on an opposing side by the layer of metal 204. The method then entails filling the mold cavity 206 with resin material 205 so that the resin material is in contact with the layers of metal 203 and 204. The resin material 205 in the mold cavity 206 is then cured or hardened, with a bonding of the resin material 205 to the metal layers 203 and 204. After the curing or hardening of the resin material 205, the mold 200 is opened and composite part 2200 is removed, that part having a metal shells or outer layers 203′ and 204′ and a polymeric backing or inner layer 205′.

The resin material 205 may be mixed with a filler material prior to the filling of the mold cavity 206, where the filler material is a mineral or metal powder and/or fiber. The mineral or metal powder may be calcium carbonate, silicon oxide, gypsum, copper, iron, zinc, bronze or mixtures thereof, while the fiber may be glass, graphite, polyester, nylon, cotton fibers or mixtures thereof. Other suitable additives may be used alone or in combination with one or more of the afore-mentioned.

Where metal layers 203 and 204 are formed by an electroforming process such as electroplating, cavity mold halves 201 and 202 serve as electrodes. Mold halves 201 and 202 may be made in part of an electrically conductive material such as a metal (metal alloys are contemplated by the term “metal” as used herein). Where mold halves 201 and 202 are made of a polymeric or other naturally non-conductive material, the electrode function may be implemented as metal inserts embedded in the mold halves 201 and 202.

The electroforming process may include inserting at least a portion of each mold half 201 and 202 into an electroforming bath, removing the mold half 201 or 202 from the bath together with the layer of metal 203 or 204 formed thereof, and washing and drying the mold half 201 or 202 together with the layer of metal 203 or 204, upon an attainment of a predetermined thickness of the layer of metal 203, 204 and prior to the filling of the mold cavity 206 with the resin material 205.

The resin material 204 may be a cold cast material. The resin material 204 is exemplarily taken from the group consisting of epoxy, polyester, and polyurethane.

In the forming of metal layers 203 and 204, the filling of the mold cavity with resin material 205 includes flowing the resin material into contact with each of the layers of metal 203 and 204. The curing or hardening of the resin material 205 is carried out so that the cured or hardened resin material is bonded to each of the layers of metal 203 and 204. The manufactured part 2200 removed from the mold 200 has metal shells or outer layers 203′ and 204′ and a single polymeric backing or core 205′ (FIG. 8). The molds 100 and 200 may be made of a material taken from the group consisting of rubber, silicon rubber, epoxy, polyester, and polyurethane.

The metal may be copper, nickel, silver or gold or mixtures (alloys) thereof.

The layer or layers of metal 102, 203, 204 are formed so that each metal shell or outer layer 102, 203, 204 103′. 203′, 204′ has a thickness between about 0.3 mm and 1.5 mm.

The composite part 1200 or 2200 made by the present process is typically a part of a toy or model article. In that case, the method further comprising applying decorative elements to the metal shell or outer layer 103′, 203′, 204′ in conformity with the toy or model article.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for manufacturing a composite part of polymer and metal, comprising:
providing a mold having a plurality of mold parts;
forming a layer of metal on at least one inner or cavity-facing surface of the mold;
after forming of said layer of metal assembling the mold parts to one another to form a mold cavity defined in part by said layer of metal;
subsequently filling said mold cavity with resin material so that said resin material is in contact with said layer of metal;
curing or hardening the resin material in said mold cavity; and
after the curing or hardening of said resin material, opening the mold and removing a part having a metal shell or outer layer and a polymeric backing or inner layer.

2. The method defined in claim 1, further comprising mixing said resin material with a filler material taken from the group consisting of mineral or metal powders and fibers and mixtures thereof.

3. The method defined in claim 2 wherein the mineral or metal powders are taken from the group consisting of calcium carbonate, silicon oxide, gypsum, copper, iron, zinc, and bronze and mixtures thereof.

4. The method defined in claim 2 wherein the fibers are taken from the group consisting of glass, graphite, polyester, nylon, and cotton fibers.

5. The method defined in claim 1 wherein the forming of said layer of metal includes electroforming said layer of metal.

6. The method defined in claim 5 wherein the electroforming of said layer of metal includes inserting at least a portion of said mold into an electroforming bath, removing the mold portion from said bath together with said layer of metal, and washing and drying the mold portion together with said layer of metal, upon an attainment of a predetermined thickness of said layer of metal and prior to the filling of said mold with said resin material.

7. The method defined in claim 1 wherein said resin material is a cold cast material.

8. The method defined in claim 7 wherein said resin material is taken from the group consisting of epoxy, polyester, polyurethane.

9. The method defined in claim 1 wherein the forming of said layer of metal includes forming a plurality of layers of metal each on an inner or cavity-facing surface of a respective one of said mold parts, the filling of said mold cavity with resin material includes flowing said resin material into contact with each of said layers of metal; the curing or hardening of the resin material being carried out so that the cured or hardened resin material is bonded to each of said layers of metal, the part removed from said mold having metal shells or outer layers and a single polymeric backing or core.

10. The method defined in claim 1 wherein said mold is made of a material taken from the group consisting of rubber, silicon rubber, epoxy, polyester, and polyurethane.

11. The method defined in claim 1 wherein said mold includes a cavity-type first mold part and a core-type second mold part, said layer of metal being formed on an inner surface of said first mold part.

12. The method defined in claim 1 wherein the metal is taken from the group consisting of copper, nickel, silver and gold.

13. The method defined in claim 1 wherein said layer of metal is formed so that said metal shell or outer layer has a thickness between about 0.3 mm and 1.5 mm.

14. The method defined in claim 1, further comprising covering at least one inward- or cavity-facing surface of the mold with mold release agent prior to the filling of said mold cavity with said resin material.

15. The method defined in claim 1 wherein the filling of said mold includes injecting said resin material into the mold to fill up a space in between a back of said layer of metal and a core half of said mold.

16. The method defined in claim 1, further comprising bonding said resin material to said layer of metal to thereby form a single part after curing.

17. The method defined in claim 1 wherein the removed part is a part of a toy or model article, further comprising applying decorative elements to said metal shell or outer layer in conformity with said toy or model article.
